(19) United States
(12) Patent Application Publication
(10) Pub. No.: US 2020/0307335 A1
(43) Pub. Date: Oct. 1, 2020

(54) ADDITIONAL SPRING FOR A SHOCK ABSORBER OF A MOTOR VEHICLE AND DAMPER BEARING FOR A SHOCK ABSORBER OF A MOTOR VEHICLE

(71) Applicant: AUDI AG, Ingolstadt (DE)

(72) Inventor: Andreas ROTH, Kipfenberg (DE)

(73) Assignee: AUDI AG, Ingolstadt (DE)

(21) Appl. No.: 16/769,356

(22) PCT Filed: Nov. 22, 2018
(86) PCT No.: PCT/EP2018/082294

§ 371 Date: Jun. 3, 2020

(30) Foreign Application Priority Data
Dec. 6, 2017 (DE) 10 2017 221 975.0

(51) Int. Cl. B60G 11/24; F16F 3/093

(52) U.S. Cl. CPC B60G 11/24; F16F 3/0935; B60G 2204/4502; B60G 15/063; B60G 2206/71043; B60G 2206/73; B60G 2204/128; B60G 2400/512

(57) ABSTRACT

An additional spring for a shock absorber of a motor vehicle and a damper bearing for a shock absorber of a motor vehicle. In this case, the additional spring includes a first spring body which has a central hole for guiding through a piston rod of the shock absorber. The first spring body is formed spherical on an end face. The damper bearing according to the invention comprises a cylindrical receptacle space in which the first spring body of the additional spring is retained at least in certain regions, and is distinguished in that the receptacle space has a spherically formed base surface formed corresponding to the end face of the first spring body.

The invention relates to an additional spring for a shock absorber of a motor vehicle according to the type specified in the preamble of claim 1 and a damper bearing for a shock absorber of a motor vehicle according to the type specified in the preamble of claim 10.

Such additional springs are sufficiently known from the prior art and are used to define the overall suspension properties of the vehicle and to form a damped end stop for a wheel suspension. For this purpose, the additional spring is arranged on a piston rod of a shock absorber, wherein the additional spring is held in the region of a damper bearing. If the motor vehicle compresses the spring very strongly, the additional spring is thus compressed between the damper cap on the damper tube of the shock absorber and the damper bearing. Furthermore, providing a progressive characteristic curve for the additional spring is known to ensure a soft spring compression and a progressive hardening of the additional spring during further increasing compression.

A generic additional spring and a generic damper bearing are disclosed in DE 10 2012 020 569 A1.

A known problem of additional springs in that they are subject to increased abrasion and thus wear in the region of the attachment to the damper bearing, which is to be attributed to the inclined spring compression—due to the inclined arrangement of the shock absorber typical in current motor vehicles—i.e., the nonparallel spring compression of the piston rod of the shock absorber in relation to the motor vehicle body.

The invention is based on the object of refining an additional spring according to the type specified in the preamble of claim 1 in such a way that a longer service life of the additional spring is ensured.

This object is achieved by the characterizing features of claim 1 in conjunction with the features of its preamble.

Dependent claims 2 to 9 provide advantageous refinements of the invention.

In a known manner, the additional spring comprises a first spring body, which has a central hole for guiding through a piston rod of the shock absorber.

It is provided according to the invention that the first spring body is formed spherical on an end face. The design according to the invention has the effect that after proper installation of the additional spring according to the invention on the piston rod of the shock absorber (=>proper installation means that after installation, the spherical end face of the spring body is oriented toward the body-side damper bearing), an “articulated” mounting is now enabled between the damper bearing and the spring body due to the spherical end face of the first spring body, by which the disadvantages of the inclined spring compression are compensated for. In this way, offset-free spring compression is advantageously ensured, with the consequence that the disadvantageous abrasion on the spring body no longer occurs or only still occurs to a lesser extent, so that a wear-free operation and thus a longer service life of the first spring body and thus of the additional spring is ensured.

A further advantageous refinement of the invention provides that the additional spring comprises a second spring body, which has a different, advantageously lower spring stiffness in relation to the first spring body and is provided with a central hole for guiding through a piston rod of the shock absorber, wherein the first spring body is arranged opposite to the spherical end face and adjoining the first spring body and thus in series with the first spring body and wherein the second spring body is also formed spherical on its end face facing away from the first spring body. It is advantageous in this design that due to the spherical formation of the end face of the second spring body, an improved angle adaptation and thus an offset-free spring compression is enabled. Moreover, an improved fine-tuning of the desired progressive characteristic curve of the spring force of the additional spring is enabled. Thus, by way of a corresponding selection of the spring stiffnesses of the two spring bodies, namely hard spring stiffness for the first spring body and very soft spring rate in comparison thereto for the second spring body, a very soft spring suspension rate with unloaded vehicle and comfort spring suspension with slight progression is enabled. A further advantage can be seen in the longer service life of an additional spring designed in this manner. This is to be attributed to the fact that in case of wear, in general only the second spring body is affected, since it is more susceptible to wear due to its lower spring stiffness and therefore only this and not the entire additional spring is to be replaced. It is moreover advantageous that due to the modular structure of the additional spring, a building block system usable for different vehicles is available, which results in a reduction of the variation variety of the additional springs and thus in a cost reduction.

In this case, the spherically formed end face of the first spring body and/or the second spring body is preferably formed in the form of a ball head.

According to a further particularly advantageous embodiment of the invention, a bump stop is arranged between the first and the second spring body, which has a central bore for guiding through the piston rod of the shock absorber corresponding to the first and second spring bodies and has a significantly higher spring stiffness in relation to the two spring bodies. In this way, a very strong progression of the additional spring, and thus a block limiting, for example, in the event of driving over a curb too fast, is ensured in a very simple manner.

In this case, the bump stop is preferably arranged in a cavity formed in the first and/or second spring body.

A further particularly advantageous embodiment of the invention provides that a piezoelectric pressure sensor is integrated into the bump stop. It is advantageous in this embodiment that a signal input for a control unit for the chassis control is provided by means of the sensor.

Preferably, the first and second spring bodies are formed from an elastomeric material, in particular from polyurethane, and the bump stop is formed from polyamide.

The invention is furthermore based on the object of refining a damper bearing for shock absorber of a motor vehicle according to the type specified in the preamble of claim 10 in such a way that the damper bearing acts to promote the desired longer service life of an additional spring designed as claimed in any one of claims 1 to 9.

This object is achieved by the characterizing features of claim 10 in conjunction with the features of its preamble.

Dependent claims 11 to 13 form an advantageous refinement of the damper bearing according to the invention.

In a known manner, the damper bearing for a shock absorber of a motor vehicle has a flange region for fastening the bearing on the vehicle body and also a cylindrical receptacle space formed as a hollow body, in which the first spring body of the additional spring is retained at least in certain regions in the installed state.

According to the invention, the receptacle space now has a spherically shaped base surface formed corresponding to the end face of the first spring element. The design according to the invention has the positive effect that now due to the opposing spherical surfaces, an optimum angle adaptation between first spring element and damper bearing is enabled, and thus the harmful effect of the inclined spring compression is significantly reduced once again.

An elastomeric bearing element for the screw connection of the piston rod of the shock absorber is preferably arranged in the flange region.

A further advantageous embodiment provides that the bearing element comprises a piezoelectric pressure sensor, which supplies corresponding input signals for a control unit for the chassis control. Due to the arrangement of the piezoelectric pressure sensor in the bearing element and thus in the damper bearing, a simplified laying of the electrical lines to the control unit, which is arranged on the body side, for the chassis control is advantageously enabled.

In this case, the base surface of the receptacle space is preferably formed in the form of a ball socket.

Further advantages and possible applications of the present invention result from the following description in conjunction with the exemplary embodiment illustrated in the drawing.

In the figures of the drawing:

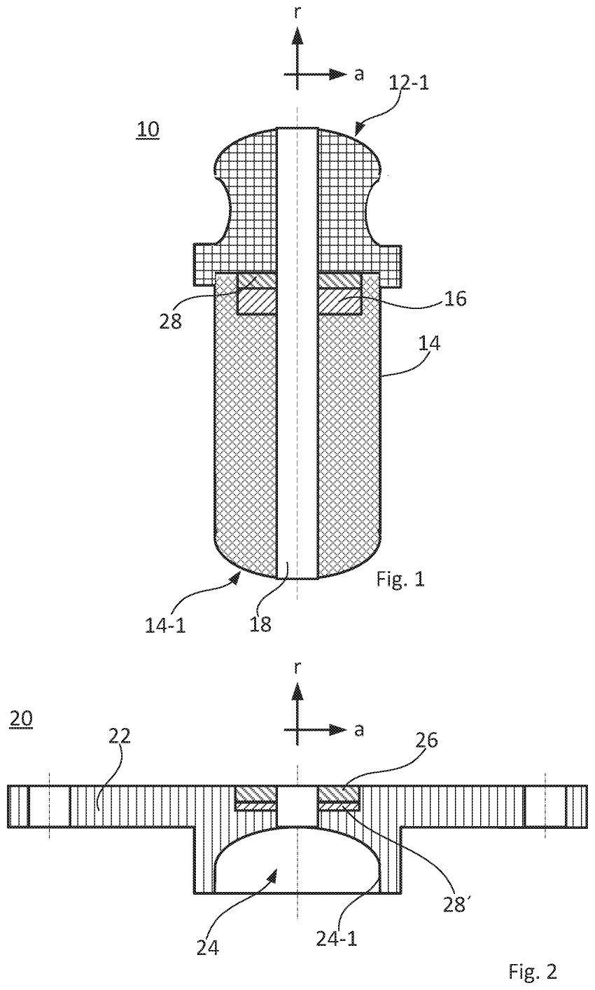

FIG. 1 shows a schematic sectional illustration of the additional spring according to the invention;

FIG. 2 shows a schematic sectional illustration of the damper bearing according to the invention; and

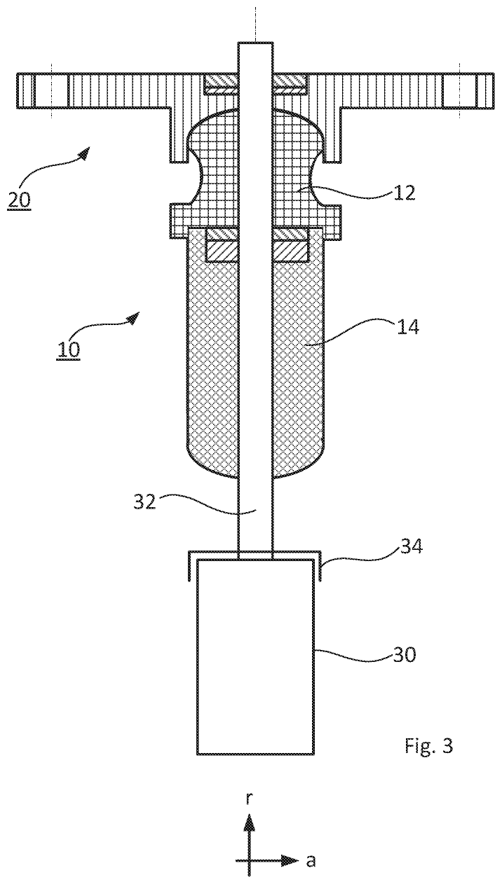

FIG. 3 shows the additional spring from FIG. 1 and the damper bearing from FIG. 2 in the installed state in a schematic sectional illustration.

FIG. 1 shows an additional spring identified as a whole by the reference sign 10. The additional spring 10 comprises a first spring body 12, a second spring body 14, and a bump stop 16.

In this case, as shown in FIG. 1, the two spring bodies 12, 14 are arranged in series viewed in the axial direction a and the first spring body 12 is formed spherical on its end face 12-1 facing away from the second spring body 14, i.e., the surface has a hemispherical design. Accordingly, the second spring body 14 is also formed spherical, in the present case again hemispherical, on its end face 14-1 facing away from the first spring body 12, via which the second spring body 14 supports itself during the spring compression on the shock absorber cap 34, cf. FIG. 3.

As can furthermore be inferred from FIG. 1, the bump stop 16 is arranged between the first and second spring body 12, 14 viewed in the axial direction a, in the present case in a cavity formed in the second spring body 14. The bump stop 16 can optionally be provided with a piezoelectric pressure sensor 28, which supplies corresponding input signals for a chassis control.

Moreover, the spring bodies 12, 14 and the bump stop 16 are each provided with a central hole 18 arranged aligned with one another.

Furthermore, the spring bodies 12, 14 and the bump stop 16 have different spring stiffnesses. The spring bodies 12, 14, which are formed from an elastomeric material, for example, polyurethane, are designed so that the first spring body 12 has a higher spring stiffness in comparison to the second spring body 14. And the bump stop 16, which is formed from a plastic material, preferably polyamide, has a spring stiffness which is even substantially higher in comparison to the first spring element 12.

FIG. 2 shows a schematic illustration of a damper bearing identified as a whole with the reference sign 20. The damper bearing 20 comprises a flange region 22 for fastening on a vehicle body and a cylindrical receptacle space 24, formed as a hollow body, for partially accommodating the first spring body 12 of the additional spring 10. Moreover, the damper bearing 20 comprises an elastomeric bearing element 26 in the flange region 22 for the screw connection of the piston rod 32 of the shock absorber 30. The damper bearing 20 can optionally be provided with a piezoelectric pressure sensor 28′, which supplies corresponding input signals to a chassis control. The arrangement of the piezoelectric pressure sensor 28′ in the damper bearing 20 has proven to be particularly advantageous, since in this way simplified laying of the electrical lines to the chassis control is enabled.

In this case, as FIG. 2 shows, the base surface 24-1 of the receptacle space 24 is formed corresponding to the spherically formed end face 12-1 of the first spring body 12. I.e., the base surface 24-1 has a counter contour correspondingly formed concave in relation to the convex shaping of the end face 12-1.

FIG. 3 shows a schematic illustration of the additional spring 10 and the damper bearing 20 in the installed state on a piston rod 32 of a shock absorber 30. Due to the design according to the invention of the contact surfaces 12-1 of the first spring body 12 and the base surface 24-1 of the damper bearing 24, a type of articulated mounting is provided between additional spring 10 and damper bearing, which causes an angle adaptation during the inclined spring compression and thus enables offset-free spring compression.

1-13. (canceled)

14. An additional spring for a shock absorber of a motor vehicle, comprising:
a first spring body, which has a central hole for guiding through a piston rod of the shock absorber, wherein the first spring body is formed spherical on an end face.

15. The additional spring as claimed in claim 14, further comprising:
a second spring body having a different spring stiffness in relation to the first spring body, wherein the second spring body has a central hole for guiding through a piston rod of the shock absorber and is arranged opposite to the spherical end face, adjoining the first spring body, and wherein the second spring body is formed spherical on its end face facing away from the first spring body.

16. The additional spring as claimed in claim 14, wherein the spherically formed end face is formed in the form of a ball head.

17. The additional spring as claimed in claim 15, further comprising:
a bump stop having a different spring stiffness in relation to the two spring bodies wherein the bump stop has a central hole for guiding through a piston rod of the shock absorber and is arranged between the first and second spring body.

18. The additional spring as claimed in claim 17, wherein the bump stop is arranged in a cavity formed in the first and/or second spring body.

19. The additional spring as claimed in claim 17, wherein a piezoelectric pressure sensor is integrated into the bump stop.

20. The additional spring as claimed in claim 16, wherein the bump stop is formed from polyamide.

21. The additional spring as claimed in claim 14, wherein the first and/or spring body are formed from an elastomeric material.

22. The additional spring as claimed in claim 21, wherein the first and/or second spring body are formed from polyurethane.

23. A damper bearing for a shock absorber of a motor vehicle, comprising:
a flange region for fastening on a vehicle body and also a cylindrical receptacle space, in which a first spring body of an additional spring with a first spring body, which has a central hole for guiding through a piston rod of the shock absorber, wherein the first spring body is formed spherical on an end face is retained at least in certain regions in the installed state, wherein the receptacle space has a spherically shaped base surface formed corresponding to the end face of the first spring body.

24. The damper bearing as claimed in claim 23, wherein an elastomeric bearing element is arranged in the flange region.

25. The damper bearing as claimed in claim 24, wherein the elastomeric bearing element comprises a piezoelectric pressure sensor.

26. The damper bearing as claimed in claim 23, wherein the base surface of the receptacle space is formed in the form of a ball socket.

27. The additional spring as claimed in claim 15, wherein the first and/or spring body are formed from an elastomeric material.

28. The additional spring as claimed in claim 16, wherein the first and/or spring body are formed from an elastomeric material.

29. The additional spring as claimed in claim 17, wherein the first and/or spring body are formed from an elastomeric material.

30. The additional spring as claimed in claim 18, wherein the first and/or spring body are formed from an elastomeric material.

31. The additional spring as claimed in claim 19, wherein the first and/or spring body are formed from an elastomeric material.

32. The additional spring as claimed in claim 20, wherein the first and/or spring body are formed from an elastomeric material.

33. The damper bearing as claimed in claim 24, wherein the base surface of the receptacle space is formed in the form of a ball socket.
